(19) United States
(12) Patent Application Publication
(10) Pub. No.: US 2003/0057394 A1
(43) Pub. Date: Mar. 27, 2003

(54) Electromagnetic fluid control device having magnetostrictive member

(76) Inventor: Tadaaki Makino, Nukata-gun (JP)

Correspondence Address: Larry S. Nixon, Esq., NIXON & VANDERHYE P.C., 8th Floor, 1100 North Glebe Rd., Arlington, VA, 22201-4714, US

(21) Appl. No.: 10/217,481

(22) Filed: Aug. 14, 2002

(30) Foreign Application Priority Data
Sep. 26, 2001 (JP) 2001-294219

(51) Int. Cl. F16K 31/02

(52) U.S. Cl. 251/129.06; 310/26

(57) ABSTRACT

A pressure-reducing valve for a common rail fuel injection system as a variable restrictor has a valve needle, a super magnetostrictive member, which is disposed so that it faces the valve needle, and the like. The super magnetostrictive member extends toward the valve needle against force urged by a spring when a magnetic field is applied by supplying electric current to a coil wound around the super magnetostrictive member. Thus a lifting distance of the valve needle from a valve seat formed on a valve body is adjusted precisely and an opening area of a fuel channel provided by the variable restrictor is determined. Therefore, fuel pressure of the common rail is adjusted suitably at required values by controlling magnitude of the current provided to the coil.

### CROSS REFERENCE TO RELATED APPLICATION

This application is based on and incorporates herein by reference Japanese Patent Application No. 2001-294219 filed Sep. 26, 2001.

### BACKGROUND OF THE INVENTION

1. Field of the Invention

The present invention relates to an electromagnetic fluid control device as a variable restrictor, which variably controls a cross-sectional opening area of a fluid channel provided by the variable restrictor.

2. Description of Related Art

Heretofore, as a kind of variable restrictors, which belong to electromagnetic fluid control devices, a pressure-reducing valve to control fuel pressure of a common rail fuel injection system for a diesel engine is known. The variable restrictor variably controls a cross-sectional opening area of a fluid channel provided therein.

As a variable restrictor to control the fuel pressure of the common rail, an ON-OFF valve is applicable. The on-off valve controls flow volume passing through the fluid channel by duty ratio of electric current. A linear solenoid valve is also applicable as a variable restrictor. The linear solenoid valve adjusts the cross-sectional opening area of the fluid channel by controlling the electric current flow.

However, the on-off valve has a disadvantage that it cannot control lifting distance of a valve needle precisely, though it responses better than the linear solenoid valve. On the other hand, the solenoid valve has a disadvantage that it is not adoptable in systems in which the lifting distance of the valve needle has to be controlled against force urged by a spring. It is because the linear solenoid valve is less forceful in attracting the valve needle than the on-off valve. In addition, in using the linear solenoid valve, switching elements are controlled in duty ratio to prevent hysteresis caused by sliding friction of movable portions. Thus the movable portions are continuously reciprocated, and the lifting distance of the valve needle is controlled as an average value. Therefore it is difficult to control the lifting distance of the valve needle in a precise manner in micrometer-order.

### SUMMARY OF THE INVENTION

It is therefore an object of the present invention to provide an electromagnetic fluid control device that controls lifting distance of a valve needle precisely and thus suitably adjusts a cross-sectional opening area of fluid channel defined by the valve needle.

According to one aspect of the invention, an electromagnetic fluid control device comprises a valve needle disposed in a valve body, a column-shaped super magnetostrictive member disposed in a body adapter that is fixed on the valve body, and the like. The super magnetostrictive member is made of super magnetostrictive material and is surrounded by a bobbin wound with a coil. When the coil is supplied with electric current, the super magnetostrictive member extends toward a valve seat formed on the valve body against a spring while limiting the lifting distance of the valve needle from the valve seat. Thus, the lifting distance of the valve needle is controlled precisely. As a result, the maximum opening area of the fluid channel is determined suitably as required.

When the current supplied to the coil is increased, the super magnetostrictive member extends more toward the valve seat and therefore approaches the valve needle. As a result, the lifting distance of the valve needle is limited to be shorter. This device may be connected to a common rail. Fuel pressure of the common rail may be adjusted at required values by controlling magnitude of the current supplied to the coil.

The super magnetostrictive member may be made of super magnetostrictive material such as an alloy comprising Terbium and Dysprosium of rare earth metals. Such super magnetostrictive material has excellent magnetostrictive features of a high electromechanical coupling factor and a prominently high magnetostrictive saturation value among magnetoelastic materials, which change shapes in corresponding to intensity of magnetization when a magnetic field is applied. Therefore, the lifting distance of the valve needle is controlled precisely in micrometer-order and, in addition, the control range of extension of the super magnetostrictive member of the restrictor is set wide.

Moreover, The opening area of the fluid channel provided by the variable restrictor may also be controlled at required values by lifting the valve needle precisely instead of limiting the lifting distance. In this case, the super magnetostrictive member is disposed so that it extends and lifts the valve needle from the valve seat when the current is supplied to the coil surrounding the super magnetostrictive member.

### BRIEF DESCRIPTION OF THE DRAWINGS

The above and other objects, features and advantages of the present invention will become more apparent from the following detailed description made with reference to the accompanying drawings. In the drawings:

FIG. 1 is a sectional view of a pressure-reducing valve for a common rail fuel injection system according to a first embodiment of the present invention;

FIG. 2 is a sectional view of the pressure-reducing valve showing operation for controlling fuel pressure of the common rail according to the first embodiment of the present invention;

FIG. 3 is a graph showing operating character of the pressure-reducing valve versus electric current according to the first embodiment of the present invention;

FIG. 4 is a sectional view of a pressure-reducing valve for a common rail fuel injection system according to a second embodiment of the present invention;

FIG. 5 is a sectional view of the pressure-reducing valve showing operation for controlling fuel pressure of the common rail according to the second embodiment of the present invention; and

FIG. 6 is a graph showing operating character of the pressure-reducing valve versus electric current according to the second embodiment of the present invention.

### DETAILED DESCRIPTION OF THE REFERRED EMBODIMENT

First Embodiment

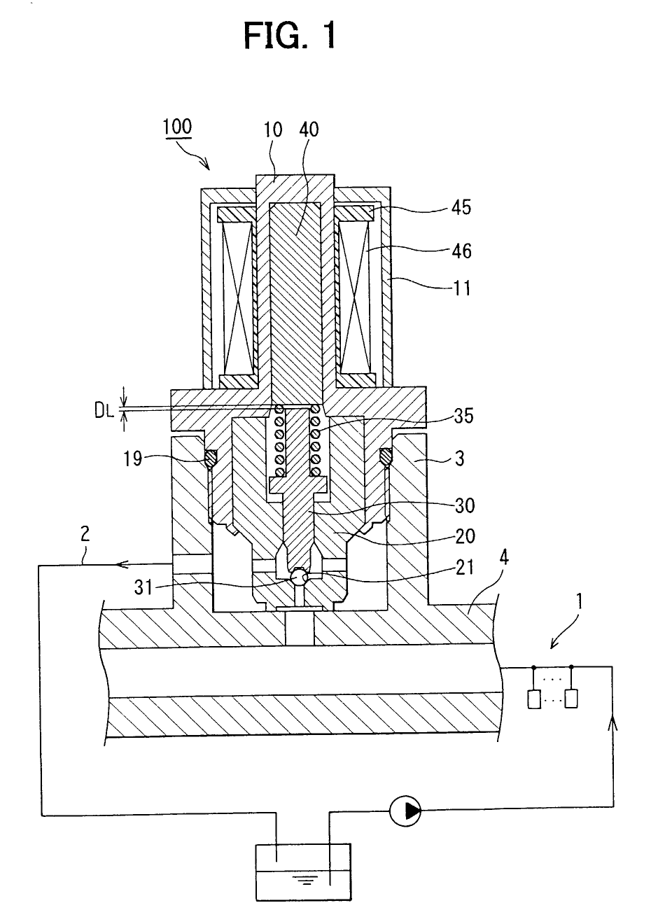

In the first embodiment shown in FIG. 1, a pressure-reducing valve 100 to control fuel pressure of a common rail 4 is disclosed. The pressure-reducing valve 100 is connected to a common rail fuel injection system 1 for a diesel engine and works as a variable restrictor to variably control an opening area of a fuel channel provided by the variable restrictor into a returning path 2.

A valve seat 21 is formed on an inner surface of a valve body 20 of the pressure-reducing valve 100.

A valve needle 30 is disposed inside the valve body 20 in an axial direction in a reciprocating manner. The valve needle 30 holds a ball 31 on an end thereof that is proximate to the valve seat 21. The valve needle 30 is reciprocated in the valve body 20 so that the valve needle 30 contacts the valve seat 21 through the ball 31 to shut the fuel channel and leaves the valve seat 21 to open the fuel channel. Thus, the opening area of the fuel channel provided by the variable restrictor is controlled variably.

A column-shaped super magnetostrictive member 40 is disposed in a body adapter 10 so that the super magnetostrictive member 40 faces an end of the valve needle 30, which is opposite to the valve seat 21. The pressure-reducing valve 100 has a clearance between the valve needle 30 and the super magnetostrictive member 40. The super magnetostrictive member 40 is made of super magnetostrictive material such as an alloy referred to as Terfenol-D, which comprises Terbium and Dysprosium of rare earth metals.

A spring 35 is disposed in contact with the valve needle 30 and the super magnetostrictive member 40 so that the spring 35 urges the valve needle 30 and the super magnetostrictive member 40 to widen the clearance therebetween, that is, in a closing direction of the pressure-reducing valve 100.

A front end of the body adapter 10, that is an end nearer to the common rail 4, is press-fitted around an outer periphery of the valve body 20. A bobbin 45 wound with a coil 46 is disposed around the outer periphery of the body adapter 10. A cap member 11 further surrounds the bobbin 45 and the coil 46. A portion of the body adapter 10 that involves the super magnetostrictive member 40 is integrally formed with another portion of the body adapter 10 that is press-fitted around the outer periphery of the valve body 20. The pressure-reducing valve 100 is fluid-tightly fitted to the common rail 4 by screwing a front end of the body adapter 10 into a cylindrical attaching part 3 of the common rail 4 with an O-ring 19. The body adapter 10 presses down the valve body 20 toward the common rail 4 when it is screwed into the attaching part 3 so that the valve body 20 contacts the common rail 4 in a sealing manner.

The pressure-reducing valve 100 as constructed above operates as follows.

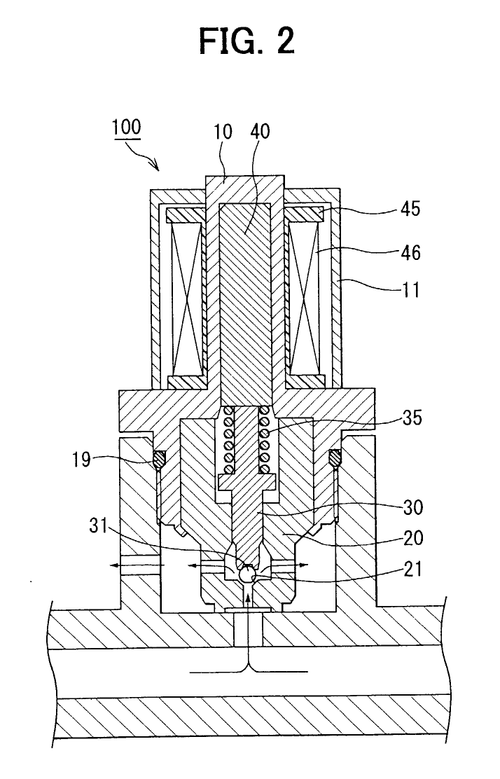

In a state shown in FIG. 1, when fuel pressure of the common rail acts on the ball 31, the valve needle 30 and the ball 31 are lifted until the force of the spring 35 is balanced as shown in FIG. 2. The lift of the valve needle 30 is limited within a lifting distance DL that is a distance of the clearance between the valve needle 30 and the super magnetostrictive member 40. Therefore, the lift is maximized when the both end faces of the valve needle 30 and the super magnetostrictive member 40 contact each other as shown in FIG. 2. The opening area S of the fuel channel is determined by the valve seat 21 and the ball 31, and the fuel from the common rail flows through the fuel channel as shown by arrows in FIG. 2.

The pressure-reducing valve 100 controls the fuel pressure of the common rail 4 at required values as follows.

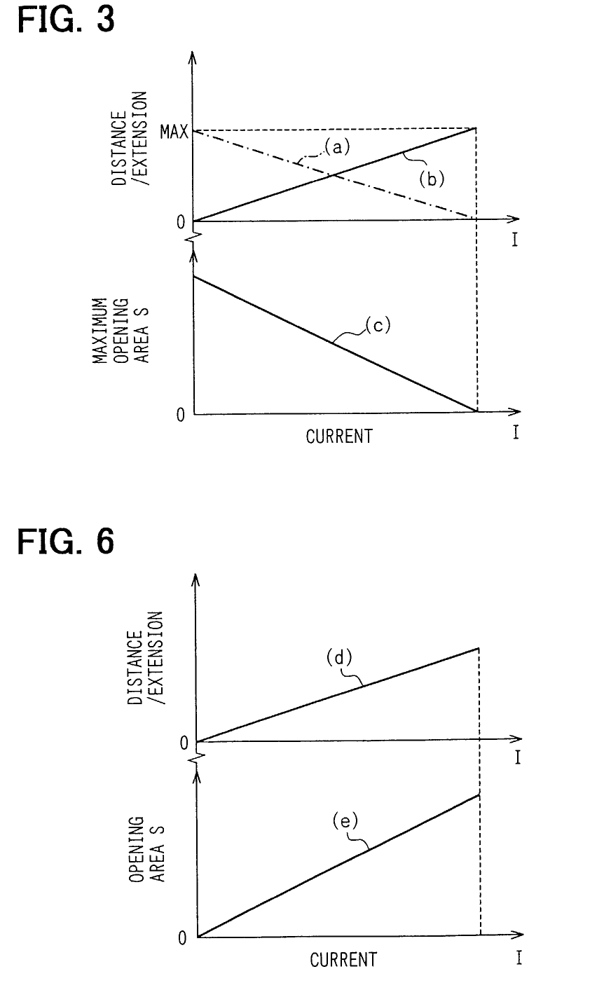

In FIG. 3, the line (a) represents the lifting distance DL of the valve needle 30. The line (b) in FIG. 3 represents the extension of the super magnetostrictive member 40. The line (c) in FIG. 3 represents the maximum opening area S of the fuel channel provided by the pressure-reducing valve 100.

The super magnetostrictive member 40 extends substantially in proportion to increase of the current supplied to the coil 46 as shown by the line (b) in FIG. 3. When the super magnetostrictive member 40 extends, the lifting distance DL of the valve needle 30 is decreased as much as shown by the line (a) in FIG. 3, and the maximum value of the opening area S of the fuel channel is reduced likewise as shown by the line (c) in FIG. 3. When the current supplied to the coil 46 is increased so far as the extension of the super magnetostrictive member 40 equals the maximum lifting distance DL, which is attained when the coil 46 is supplied with no current, the ball 31 contacts the valve seat 21 immovably. Whereat the opening area S of the fuel path equals zero and the pressure-reducing valve 100 is fully closed. Therefore, the maximum opening area S of the fuel channel provided by the pressure-reducing valve 100 is adjusted by controlling the current supplied to the coil 46. Accordingly, magnitude of the current supplied to the coil 46 is adjusted in feedback control so that the fuel pressure of the common rail 4, which is measured by a pressure gauge, meets the required values.

In addition, the super magnetostrictive member 40 is almost free of hysteresis when changing its extension. Therefore, the fuel pressure of the common rail 4 is adjusted to required values very quickly.

Moreover, the super magnetostrictive member 40 in the pressure-reducing valve 100 is formed by super magnetostrictive material made of an alloy comprising Terbium and Dysprosium of rare earth metals. Therefore, the super magnetostrictive member has excellent magnetostrictive features of a high electromechanical coupling factor and a prominently high magnetostrictive saturation among the magnetoelastic materials that change shapes in corresponding to intensity of magnetization when a magnetic field is applied. As a result, a control range of the extension of the super magnetostrictive member is set wide and the opening area S of the fuel channel is adjusted suitably as required.

In this embodiment, the ball 31 held on the front end of the valve needle 30 contacts the valve seat 21 of the valve body 20. Instead, the front end of the valve needle 30 may be formed in a conical shape to contact the valve seat 21 directly.

Second Embodiment

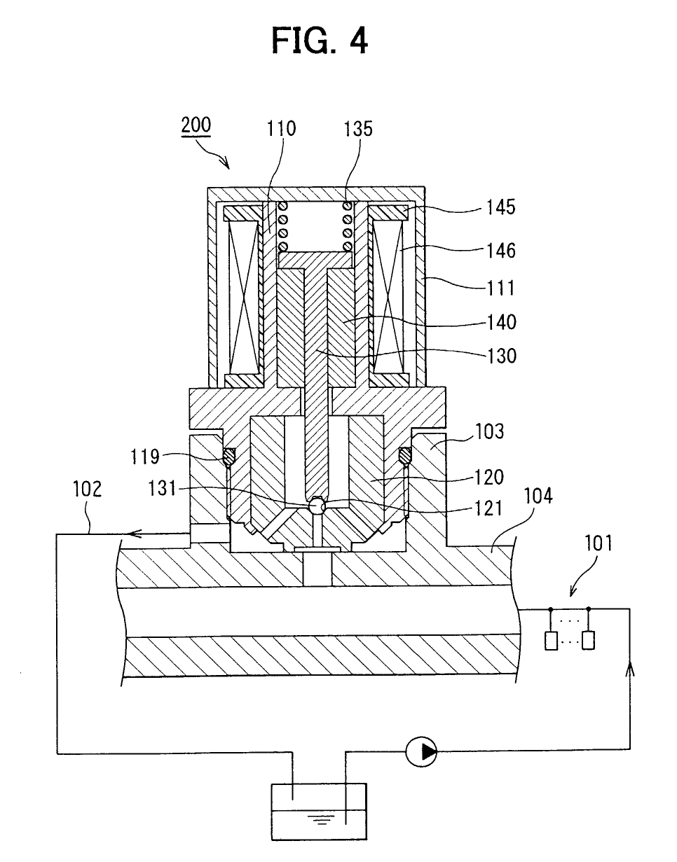

In the second embodiment shown in FIG. 4, a pressure-reducing valve 200 to control the fuel pressure of a common rail is disclosed. The pressure-reducing valve 200 is connected to a common rail fuel injection system 101 for a diesel engine and works as a variable restrictor to variably control an opening area of fuel channel provided by the variable restrictor into a returning path 102. A valve seat 121 is formed on an inner surface of a valve body 120 of the pressure-reducing valve 200.

A cylindrical super magnetostrictive member 140 made of super magnetostrictive material, which is similar to the super magnetostrictive material shown in the first embodiment, is disposed in a body adapter 110. A front end of the body adapter 110, which is an end nearer to the common rail, is press-fitted around an outer periphery of the valve body 120. A bobbin 145 wound with a coil 146 is disposed around the outer periphery of the body adapter 110. A cap member 111 further surrounds the bobbin 145 and the coil 146.

A valve needle 130 is disposed inside the valve body 120 in an axial direction in a reciprocating manner. The valve needle 130 holds a ball 131 on an end thereof that is proximate to the valve seat 121. The valve needle 130 is reciprocated in the valve body 120 so that the valve needle 130 contacts the valve seat 121 through the ball 131 to shut the fuel channel and leaves the valve seat 121 to open the fuel channel. Thus, the opening area of the fuel channel provided by the variable restrictor is controlled variably.

A spring 135 is disposed between the valve needle 130 and the cap member 111 so that the spring 135 urges the valve needle 130 toward the valve seat 121, that is, in a closing direction. A portion of the body adapter 110 that involves the super magnetostrictive member 140 is integrally formed with another portion of the body adapter 110 that is press-fitted around the outer periphery of the valve body 120. The pressure-reducing valve 200 is fluid-tightly fitted to the common rail 104 by screwing a front end of the body adapter 110 into a cylindrical attaching part 103 of the common rail 104 with an O-ring 119. The body adapter 110 presses down the valve body 120 toward the common rail 104 when it is screwed into the attaching part 103 so that the valve body 120 contacts the common rail 104 in a sealing manner.

The pressure-reducing valve 200 as constructed above operates as follows.

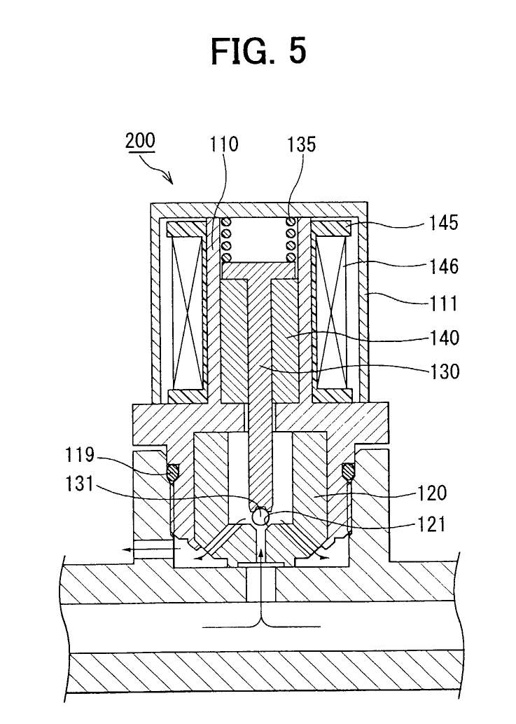

In a state shown in FIG. 4, fuel pressure of the common rail 104 is acting on the ball 131. In such a state, when the super magnetostrictive member 140 extends as shown in FIG. 5, the valve needle 130 is raised by the super magnetostrictive member 140 against force of the spring 135, while holding the ball 131. The lifting distance of the valve needle 130 is determined equally to the extension of the super magnetostrictive member 140 as is described later. The opening area S of the fuel channel is determined by the valve seat 121 and the ball 131, and the fuel from the common rail 4 flows through the fuel channel as shown by arrows in FIG. 5.

The pressure-reducing valve 200 controls the fuel pressure of the common rail 104 at required values as follows.

In FIG. 6, the line (d) represents the lifting distance of the valve needle 130 and the extension of the super magnetostrictive member 140. The line (e) in FIG. 6 represents the opening area S of the fuel channel provided by the pressure-reducing valve 200.

As shown in FIG. 6, when the current provided to the coil 146 is zero, the extension of the super magnetostrictive member 140 is zero and the lifting distance of the valve needle 130 is also zero as shown by the line (d) in FIG. 6. At this time, the ball 131 contacts the valve seat 121 immovably so that the pressure-reducing valve 200 is fully closed, and the opening area S of the fuel channel is zero as shown by the line (e) in FIG. 6.

The super magnetostrictive member 140 extends substantially in proportion to the increase of the current supplied to the coil 146 as shown by the line (d) in FIG. 6. When the super magnetostrictive member 140 extends, the lifting distance of the valve needle 130 is increased equally as shown by the line (d) in FIG. 6, and the opening area S of the fuel channel is widened likewise as shown by the line (e) in FIG. 6. Therefore, the opening area S of the fuel channel provided by the pressure-reducing valve 200 is adjusted at required values by controlling the current provided to the coil 146. Accordingly, magnitude of the current passing through the coil 146 is adjusted in feedback control so that the fuel pressure of the common rail 4, which is measured by a pressure gauge, meets the required values.

In addition, the super magnetostrictive member 140 is almost free of hysteresis when changing its extension. Therefore, the fuel pressure of the common rail 104 is adjusted to the required values very quickly.

Moreover, the super magnetostrictive member 140 in the pressure-reducing valve is formed by super magnetostrictive material made of an alloy comprising Terbium and Dysprosium of rare earth metals. Therefore, the super magnetostrictive member has excellent magnetostrictive features of a high electromechanical coupling factor and a prominently high magnetostrictive saturation among the magnetoelastic materials that change shapes in corresponding to intensity of magnetization when a magnetic field is applied. As a result, a control range of the extension of the super magnetostrictive member is set wide and the opening area S of the fluid channel is adjusted suitably as required.

In this embodiment, the ball 131 held on the front end of the valve needle 130 contacts the valve seat 121 of the valve body 120. Instead, the front end of the valve needle 130 may be formed in a conical shape to contact the valve seat 121 directly.

What is claimed is:

1. An electromagnetic fluid control device comprising:
a valve needle disposed in a valve body having a valve seat formed on an inner surface thereof, the valve needle being reciprocated in the valve body so that the valve needle contacts the valve seat to shut a fluid channel and leaves the valve seat to open the fluid channel;
a column-shaped super magnetostrictive member made of super magnetostrictive material disposed so that it can contact an end of the valve needle which is opposite to the valve seat; and
a body adapter fixed on the valve body for housing the super magnetostrictive member, surrounded by a bobbin wound with a coil,
wherein the super magnetostrictive member extends toward the valve seat when the coil is supplied with electric current against force of a spring disposed to urge the valve needle in a closing direction, thereby limiting a lifting distance of the valve needle from the valve seat.

2. The electromagnetic fluid control device as in claim 1, wherein:
the super magnetostrictive member extends toward the valve seat and limits the lifting distance of the valve needle to be shorter as current supplied to the coil is increased.

3. An electromagnetic fluid control device comprising:
a valve needle disposed in a valve body having a valve seat formed on an inner surface thereof, the valve needle being reciprocated in the valve body so that the valve needle contacts the valve seat to shut a fluid channel and leaves the valve seat to open the fluid channel;
a cylindrical super magnetostrictive member made of super magnetostrictive material disposed around the valve needle, connected to the valve needle; and
a body adapter fixed on the valve body for housing the super magnetostrictive member, surrounded by a bobbin wound with a coil,
wherein the super magnetostrictive member extends opposite the valve seat when the coil is supplied with electric current against force of a spring disposed to urge the valve needle in a closing direction, thereby raising a lifting distance of the valve needle from the valve seat.

4. The electromagnetic fluid control device as in claim 3, wherein:
the super magnetostrictive member extends opposite the valve seat and raises the lifting distance of the valve needle as current supplied to the coil is increased.

5. The electromagnetic fluid control device as in claim 1, wherein:
the super magnetostrictive material is an alloy comprising Terbium and Dysprosium of rare earth metals.

6. The electromagnetic fluid control device as in claim 3, wherein:
the super magnetostrictive material is an alloy comprising Terbium and Dysprosium of rare earth metals.

7. An electromagnetic fluid control device comprising:
a valve member for providing a cross-sectional area of a fluid channel; and
a super magnetostrictive member made of a super magnetostrictive material which changes its shape and shifts the valve member in corresponding to intensity of a magnetic field applied thereto, whereby controlling the cross-sectional area of the fluid channel provided by the valve member.

8. The electromagnetic fluid control device as in claim 7, wherein:
the super magnetostrictive material is an alloy comprising Terbium and Dysprosium of rare earth metals.

9. The electromagnetic fluid control device as in claim 7, wherein:
the electromagnetic fluid control device is connected to a common rail fuel injection system as a pressure-reducing valve.

10. The electromagnetic fluid control device as in claim 7, wherein:
the valve member and the super magnetostrictive member are surrounded by an integral covering member fluid-tightly, and
the super magnetostrictive member is applied with a magnetic field through the covering member.

11. The electromagnetic fluid control device as in claim 7, wherein:
the electromagnetic fluid control device is a threaded type.
